(19) United States
(12) Patent Application Publication
(10) Pub. No.: US 2025/0361660 A1
(43) Pub. Date: Nov. 27, 2025

(54) GAS DIFFUSION LAYER MADE OF WATER JET ENTANGLED NONWOVENS

(71) Applicant: Carl Freudenberg KG, Weinheim (DE)

(72) Inventors: Achim Bock, Weinheim (DE); Kristof Klein, Weinheim (DE); Christoph Rakousky, Ober-Ramstadt (DE); Hannes Barsch, Heidelberg (DE); Klaus Hirn, Hirschberg (DE); Klaus-Dietmar Wagner, Heddesheim (DE); Matthias Loeble, Mannheim (DE); Amelie Von Spee, Mannheim (DE)

(21) Appl. No.: 18/873,746

(22) PCT Filed: May 9, 2023
(86) PCT No.: PCT/EP2023/062188

§ 371 Date: Dec. 11, 2024

(30) Foreign Application Priority Data
Jun. 13, 2022 (DE) 102022114789.4

(51) Int. Cl. D04H 1/49; D04H 1/4242; D04H 1/43; D06C 7/04; D06M 11/74; D06M 11/84; D06M 15/256; D06M 15/71; D06M 101/40; D06N 3/00; D06N 3/04; H01M 4/88; H01M 8/0234; H01M 8/0239; H01M 8/0245

(52) U.S. Cl. CPC D04H 1/49; D04H 1/4242; D04H 1/43; D06C 7/04; D06M 11/74; D06M 11/84; D06M 15/256; D06M 15/71; D06N 3/0011; D06N 3/0015; D06N 3/0063; D06N 3/0077; D06N 3/047; H01M 4/8807; H01M 8/0234; H01M 8/0239; H01M 8/0245; D06M 2101/40; D06M 2200/12; D06N 2201/087; D06N 2209/041; D10B 2505/00

(57) ABSTRACT

The present invention relates to a method for producing a gas diffusion layer, wherein nonwovens made of carbon fibers or carbon fiber precursors are subjected to entanglement with water-containing fluid jets of a certain water quality. The invention also relates to the gas diffusion layer obtainable according to the method and to a fuel cell that contains such a gas diffusion layer.

### CROSS REFERENCE TO RELATED APPLICATIONS

This application is a U.S. National Phase application under 35 U.S.C. § 371 of International Application No. PCT/EP2023/062188, filed on May 9, 2023, and claims benefit to German Patent Application No. DE 10 2022 114 789.4, filed on Jun. 13, 2022. The International Application was published in German on Dec. 21, 2023, as WO 2023/241861 A1 under PCT Article 21(2).

### FIELD

The present invention relates to a method for manufacturing a gas diffusion layer, to the gas diffusion layer obtainable by this method and to a fuel cell containing such a gas diffusion layer.

### BACKGROUND

Fuel cells use the chemical conversion of a fuel, in particular hydrogen, with oxygen to form water, in order to generate electrical energy. In hydrogen-oxygen fuel cells, hydrogen or a hydrogen-containing gas mixture is fed to the anode, where electrochemical oxidation takes place with the release of electrons (H₂→2H⁺+2 e⁻). The protons are transported from the anode chamber to the cathode chamber via a membrane that separates the reaction chambers from each other in a gas-tight manner and insulates them electrically. The electrons provided at the anode are fed to the cathode via an external conductor circuit. Oxygen or a gas mixture containing oxygen is fed to the cathode, whereby a reduction of oxygen takes place under absorption of electrons. The oxygen anions formed thereby react with the protons transported across the membrane under formation of water (½O₂+2 H⁺+2 e⁻→H₂ O).

Low-temperature proton exchange membrane fuel cells (PEMFCs, also known as polymer electrolyte membrane fuel cells) are used for many applications, especially in automotive powertrains, the core element of which is a polymer electrolyte membrane (PEM), which is only permeable to protons (or oxonium ions H O₃⁺) and water and spatially separates the oxidizing agent, generally atmospheric oxygen, from the reducing agent. A catalyst layer, which forms the electrodes and usually contains platinum as the catalytically active metal, is applied to the gas-tight, electrically insulating, proton-conducting membrane on the anode and cathode side. The actual redox reactions and charge separations take place in the catalyst layers. The membrane and catalyst layers form a unit, which is also referred to as a CCM (catalyst coated membrane). On both sides of the CCM there is a gas diffusion layer (GDL), which stabilizes the cell structure and performs transport and distribution functions for reaction gases, water, heat and electricity. The membrane, electrodes and gas diffusion layer form the membrane electrode assembly (MEA). Flow distribution plates (so-called bipolar plates) are arranged between the membrane-electrode-units, which have channels for supplying the adjacent cathode and anode with process gases and, as a rule, additional internal cooling channels.

The gas diffusion layers between the flow distributor plates and the catalyst layers are of key importance for the function and performance of the fuel cell. The process components consumed and generated in the electrode reactions must be transported through the gas diffusion layer and distributed homogeneously from the macroscopic structure of the flow distributor plates/bipolar plates to the microscopic structure of the catalyst layers. The electrons formed and consumed in the half-cell reactions must be conducted to the flow distributor plates with the lowest possible voltage loss. The heat generated during the reaction must be dissipated to the coolant in the flow distributor plates, so that the materials of the GDL must also possess sufficient thermal conductivity. In addition, the GDL must also act as a mechanical balance between the macro-structured flow distributor plate and the catalyst layers.

Gas diffusion layers for fuel cells typically consist of a carbon fiber substrate, which is usually made hydrophobic by the addition fluoropolymers (e.g. PTFE) and then coated with a microporous layer (MPL). The MPL usually consists of a fluorine-containing polymer as a binder (e.g. PTFE) and a porous and electrically conductive carbon material (e.g. carbon black or graphite powder). The following three materials are currently used as carbon fiber substrates for the GDL:
Carbon fiber papers (wetlaid and chemically bonded carbon fiber nonwovens, with chemical binders that are carbonized),
Carbon fiber fabrics (e.g. made from yarns of oxidized but not yet carbonized polyacrylonitrile fibers, which are carbonized and/or graphitized after weaving),
Carbon fiber nonwovens (e.g. drylaid, carded and hydroentangled nonwovens made of oxidized polyacrylonitrile, which are subsequently thickness-calibrated and carbonized).

It is known that fuel cells can be contaminated by the introduction of foreign ions that are not involved in the electrode processes. Thus, for example, the influence of the materials of the bipolar plates and the cations and anions introduced from these into the MEA of the fuel cell on the cell performance was analyzed. Other sources, especially for metallic cations, are emissions from the other materials of the cell, the system components such as the tank, heat exchanger, piping, etc., the air supply flow to the cathode and contaminations of the hydrogen through production or transportation. One possible problem with introduced metallic ions is that they can be easily absorbed by the electrolyte membrane. The reason for this is the strong affinity of the metal cations to the sulfonic acid groups of the perfluorinated cation exchanger membrane, which is generally greater than the affinity of the protons to the sulfonic acid groups.

It has now been found that also the GDL can contribute to the charging of the MEA with foreign ions. There is therefore a need for gas diffusion layers that only contain very low concentrations of ions, especially metal cations, and for methods to produce them. In particular, the GDL should have low concentrations of cations, such as those normally contained in water for technical applications, such as calcium, magnesium, sodium and potassium ions. Thereby the other mechanical properties of the GDL should not be adversely affected.

For the manufacture of carbon fiber nonwovens, nonwovens made of carbon fibers or carbon fiber precursors can be subjected to a bonding process by the action of aqueous fluid jets. Such entanglement processes (spunlace process) for web bonding with fluid jets and streams, including entanglement with superheated steam jets, are known to those skilled in the art. A special method for the mechanical bonding of nonwovens is hydroentanglement, in which water at an increased pressure of around 20 to over 400 bar is directed through a large number of nozzles onto the nonwoven to be bonded. The impulse force of the water jets leads to a mechanical anchoring of the fibers in the product. So-called nozzle strips, which can be arranged in one or more rows, serve as a tool for this method. Each row has a large number of nozzles. The maximum number of nozzles per strip can be up to 20,000, with typical nozzle diameters ranging from 0.05 to 0.3 mm.

WO 2021/170608 A1 describes a method for the manufacture of spunlaid nonwovens, in which these are subjected to hydroentanglement and subsequently to washing. Fresh water can thereby be supplied to the hydroentanglement process and the waste water from the hydroentanglement process can be supplied to the washing process. It is generally mentioned that a fully demineralized water can be used as fresh water.

US 2003/182730 A1 describes a nonwoven with a low content of ionic impurities, which is achieved by washing with water with a low ion concentration. These nonwovens are used, among other things, in cleaning cloths and protective clothing for cleanrooms. An application for the production of a gas diffusion layer for a fuel cell is not described.

WO 0231841 A2 describes a conductive nonwoven obtained from a fibrous web of pre-oxidized fibers for carbon fibers by bonding the fibrous web with high-pressure fluid jets at pressures of 100 to 300 bar, densifying the bonded nonwoven and subsequent carbonization and/or graphitization under a protective gas atmosphere at temperatures of 800° C. to 2500° C.

DE 10 2006 060 932 A1 describes temperature-stable structures comprising fibers and a coating, wherein this coating is covalently bonded to the surface of the fibers. In particular, these are conductive nonwovens that have been subjected to a plasma coating with fluorinated hydrocarbons and are suitable as a gas diffusion layer for fuel cells. For the production of the conductive nonwoven, carbon fibers or carbon fiber precursors are laid to form a fibrous web and bonded by the action of high-pressure fluid jets and then pre-dried, calendered and carbonized.

US 2019/0165379 A1 describes a material for a gas diffusion layer based on a carbon fiber nonwoven which has areas with high and areas with low basis weights in the plane and wherein at least one of the surfaces of the nonwoven has an uneven pattern with indentations and elevations, which pattern is independent of the weight distribution of the fibers. The manufacture of the nonwoven comprises a water jet process.

None of the last four documents mentioned contain information on the quality of the water used for water jet treatment.

International application PCT/EP2021/085452 (WO 2022/128895 A1) describes a gas diffusion layer with high purity and a method for its manufacture, in which nonwovens made of carbon fibers or carbon fiber precursors are subjected to a bonding with aqueous fluid jets, wherein the water has a conductivity of at most 250 microsiemens/cm at 25° C. Information on the pH value of the water used in the water jet treatment is not available.

### SUMMARY

In an embodiment, the present disclosure provides a method for manufacturing a gas diffusion layer for a fuel cell, comprising a) providing a fiber composition comprising carbon fibers and/or precursors of carbon fibers, b) subjecting the fiber composition provided in step a) to a process for manufacturing a fibrous web, and c) bonding the fibrous web to form a nonwoven by action of aqueous fluid jets, wherein water used has a pH value in a range from 5.5 to 8.0. The method further comprises d) subjecting the nonwoven obtained in step c) to a thermal and/or mechanical treatment for drying and/or further bonding and e) subjecting the nonwoven to pyrolysis at a temperature of at least 1000° C. based on whether the fiber composition used in step a) comprises precursors of carbon fibers.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows the metal contents (Ca2+, Na+, Mg2+ and K+) of an untreated nonwoven and a nonwoven bonded with water of varying conductivity;

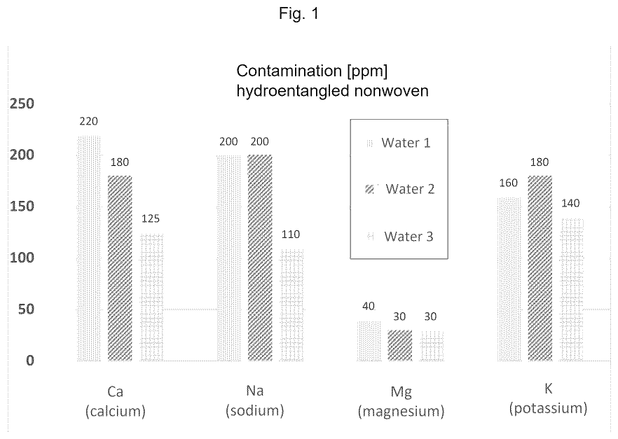

FIG. 2 shows the content of Ca2+ and Na+ ions of a base nonwoven bonded with water of varying conductivity, the carbon fiber nonwoven obtained from it by carbonization and a gas diffusion layer obtained after application of an MPL; and

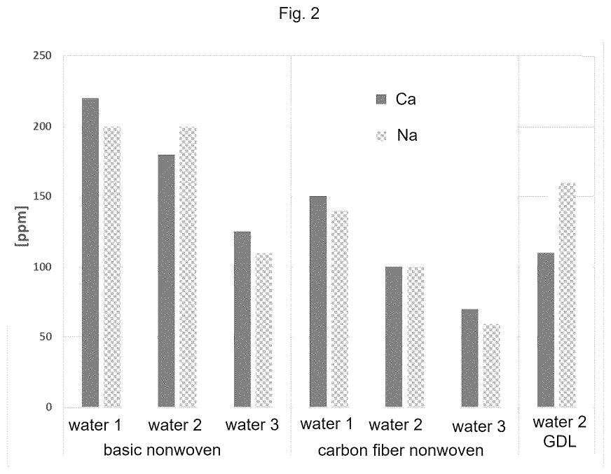

FIG. 3 shows the sum of the content of Ca2+ and Na+ ions, analogous to FIG. 2.

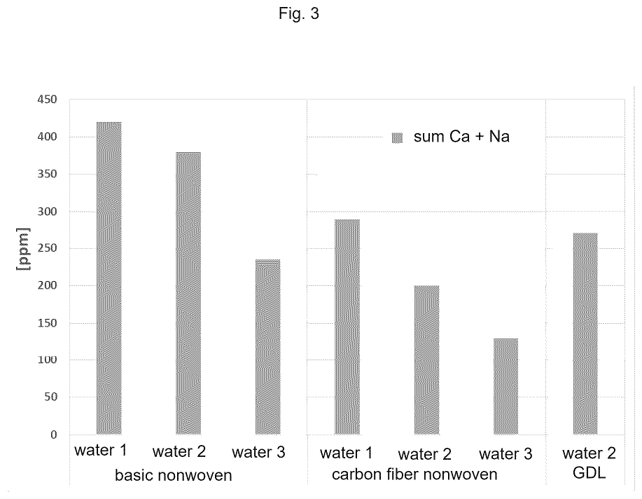

### DETAILED DESCRIPTION

It has now been found that high-quality and especially high-purity carbon fiber nonwovens can be produced by subjecting dry-laid nonwovens made of carbon fibers or carbon fiber precursors to a bonding by the action of water-containing fluid jets. Thereby, the quality of the water used for bonding is of critical importance here.

The pH value of the water is a critical parameter here, e.g. in order to remove undesirable nonwoven accompanying substances during wet bonding without the aid of a washing agent. At the same time, additives already added before this treatment step should essentially be retained. By optimizing the pH value, damage to the nonwoven caused by the water treatment can be reduced and/or avoided.

Another critical parameter is the ion concentration, i.e. the proportion of dissociated substances dissolved in a certain amount of water. Surprisingly, it is a hydroentanglement process that makes it possible to produce high-purity nonwovens with a very low ion concentration, which can be further processed to GDL with an equally very low ion concentration. Advantageously, the nonwovens obtained are characterized by a very low number of so-called nozzle strip defects. These can occur when individual nozzles of the jet strip become clogged.

In an embodiment, the invention provides a method for manufacturing a gas diffusion layer for a fuel cell, in which:
a) a fiber composition is provided, comprising carbon fibers and/or precursors of carbon fibers,
b) the fiber composition provided in step a) is subjected to a method for manufacturing a fibrous web,
c) the fibrous web is bonded to form a nonwoven by the action of aqueous fluid jets, wherein the water used has a pH value in the range from 5.5 to 8.0,
d) if necessary, the nonwoven obtained in step c) is subjected to a thermal and/or mechanical treatment for drying and/or further bonding,
e) if the fiber composition used in step a) comprises precursors of carbon fibers, the nonwoven is subjected to a pyrolysis at a temperature of at least 1000° C.
   In an embodiment, the water used in step c) has a conductance value of at most 250 microsiemens/cm at 25° C.

In an embodiment, the nonwoven from step c), d) or e) (i.e. depending on which of these steps is carried out, following the last of these steps) is finished with a hydrophobizing agent (=step f)).

In an embodiment, the nonwoven from step c), d), e) or f) (i.e. depending on which of these steps is carried out, following the last of these steps) is coated with a microporous layer (=step g)).

Embodiments of the present disclosure also relate to a fibrous web with a very low ion concentration which is bonded by the action of aqueous fluid jets (hydroentangled nonwoven). An embodiment is therefore also a nonwoven obtainable by a method in which
a) a fiber composition comprising carbon fibers and/or precursors of carbon fibers is provided,
b) the fiber composition provided in step a) is subjected to a process for manufacturing a fibrous web,
c) the fibrous web is bonded to form a nonwoven by the action of aqueous fluid jets, wherein the water used has a pH value in the range from 5.5 to 8.0.
   With regard to steps a), b) and c), full reference is made to the following embodiments of these steps.

In an embodiment, the present disclosure provides a gas diffusion layer as defined above and below, or obtainable by a method as defined above and below.

In an embodiment, the present disclosure provides a fuel cell comprising at least one gas diffusion layer as defined above and below, or obtainable by a method as defined above and below.

Unless otherwise specified below, the pH values given refer to a temperature of 25° C.

The pH value can be determined using conventional methods known to the skilled person. Preferably, the determination is carried out using an electrometric method based on measuring the voltage of an electrochemical cell, wherein one of the two half-cells is a measuring electrode and the second is a reference electrode. The potential of the measuring electrode is a function of the pH value of the measuring solution. Commercially available pH electrodes based on a pH electrode and a reference electrode, for example in the form of a combination electrode, can be used to determine the pH value. Suitable methods for determining the pH value are described in DIN EN ISO 10523-C5: 2012-04 (water quality-determination of pH value).

Measuring devices for pH value measurement via the proton activity, especially according to an electrometric method, such as the commercially available pH value measuring chains, usually have automatic or manual temperature compensation to compensate for the temperature dependence of the ion product of water.

The gas diffusion layers obtained by the method according to the present disclosure have the following advantages:
By optimizing the pH value of the water used for hydroentanglement, undesirable nonwoven accompanying substances can be removed during wet bonding without the use of a washing agent. At the same time, additives already added before this treatment step, such as stiff finishes, plasticizers, antistatic agents, hydrophobing agents, antibacterial, antimycotic or fungicidal finishes, flame retardants and other additives, are essentially retained.
By optimizing the pH value, damage to the nonwoven caused by water treatment can be reduced and/or prevented.
The carbon fiber nonwovens obtained from drylaid carbon fibers by hydroentanglement and the GDL based thereon are characterized by a very low ion concentration.
The nonwovens obtained from drylaid carbon fiber precursors by hydroentanglement and subsequent carbonization or graphitization and the GDL based thereon are characterized by a very low ion concentration.
The nonwovens obtained by hydroentanglement according to the method of the present disclosure have a very low number of so-called jet strip defects.
Compared to the GDLs previously used in the prior art, the GDLs according to the present disclosure have comparably good mechanical properties.
Fuel cells based on the GDL according to the present disclosure have a longer service life than fuel cells based on conventional GDL.

The gas diffusion layer according to the present disclosure and obtainable by the method according to the present disclosure comprises a carbon fiber nonwoven as a flat electrically conductive material. The carbon fiber nonwoven and the gas diffusion layer are flat structures which have an essentially two-dimensional, planar extension and a smaller thickness in comparison. The gas diffusion layer has a base area that generally corresponds essentially to the base area of the adjacent membrane with the catalyst layers and the base area of the adjacent flow distributor plate of the fuel cell. The shape of the base area of the gas diffusion layer can, for example, be polygonal (n-angled with n≥3, e.g. triangular, square, pentagonal, hexagonal, etc.), circular, circular segmented (e.g. semi-circular), elliptical or elliptical segmented. Preferably, the base area is rectangular or circular.

### Manufacture of the Gas Diffusion Layer

### Step A

In step a) of the method according to the present disclosure, a fiber composition comprising carbon fibers and/or precursors of carbon fibers is provided.

Preferred carbon fibers consist of at least 90% by weight, preferably at least 92% by weight, based on their total weight, of carbon. In an embodiment, carbon fibers that have undergone a graphitization can be used. These carbon fibers have a higher carbon content and then consist in particular of at least 95% by weight of carbon.

Suitable precursors for carbon fibers are fibers from synthetic or natural sources that can be converted to carbon fibers by one or more treatment steps (carbonization). These include, for example, fibers made from polyacrylonitrile-homo- and copolymers (PAN fibers), phenolic resins, polyesters, polyolefins, cellulose, aramids, polyether ketones, polyether ester ketones, polyether sulfones, polyvinyl alcohol, lignin, pitch and mixtures thereof. Preferably, the fiber composition provided in step a) comprises PAN fibers as precursor fibers or consists of PAN fibers as precursor fibers. In an embodiment, the fiber composition provided in step a) comprises PAN fibers and fibers different therefrom, preferably selected from fibers of phenolic resins, polyesters, polyolefins, cellulose, aramids, polyether ketones, polyether ester ketones, polyether sulfones, polyvinyl alcohol, lignin, pitch and mixtures thereof. Such additional polymers are preferably contained in the carbon fiber precursor in an amount of up to 50% by weight, preferably up to 25% by weight, based on the carbon fiber precursor. In an embodiment, the fiber composition provided in step a) consists exclusively of PAN fibers.

Suitable PAN fibers are selected from PAN homopolymers, PAN copolymers and mixtures thereof. PAN copolymers contain at least one comonomer polymerized therein, which is preferably selected among (meth)acrylamide, alkyl acrylates, hydroxyalkyl acrylates, alkyl ether acrylates, polyether acrylates, alkyl vinyl ethers, vinyl halides, vinyl aromatics, vinyl esters, ethylenically unsaturated dicarboxylic acids, their monoesters and diesters, and mixtures thereof. For example, the comonomer is selected from acrylamide, methyl acrylate, methyl methacrylate, ethyl acrylate, n-propyl acrylate, n-butyl acrylate, n-octyl acrylate, lauryl acrylate, stearyl acrylate, 2-ethylhexyl acrylate, benzyl acrylate, 2-hydroxyethyl acrylate, 2-hydroxypropyl acrylate, 4-hydroxybutyl acrylate, 2-methoxyethyl acrylate, 4-methoxybutyl acrylate, di-ethylene glycol ethyl ether acrylate, 2-butoxyethyl acrylate, ethyl vinyl ether, acrylic acid, methacrylic acid, itaconic acid, itaconic acid monomethyl ester, itaconic acid monolauryl ester, fumaric acid dimethyl ester, styrene, vinyl acetate, vinyl bromide, vinyl chloride, etc. If a polyacrylonitrile copolymer fiber is used as the carbon fiber precursor in step a), the proportion of comonomers is at most 20% by weight, preferably at most 10% by weight, based on the total weight of the monomers used for polymerization. Preferably, polyacrylonitrile homopolymer fibers are used as the carbon fiber precursor in step a).

PAN polymers can, for example, be spun as a solution into filaments by wet spinning and coagulation and combined into ropes (fiber bundles). PAN copolymers often have a lower melting point than PAN homopolymers and are therefore not only suitable for use in wet-spinning processes, but also in melt-spinning processes. The PAN fibers obtained in this way are usually subjected to an oxidative cyclization (also known for short as oxidation or stabilization) in an oxygen-containing atmosphere at elevated temperatures of around 180 to 300° C. The resulting chemical cross-linking improves the dimensional stability of the fibers.

The fibers obtained during oxidative cyclization can be used as precursors of carbon fibers in step a) without further processing. It is also provided to subject the fibers obtained during oxidative cyclization to at least one processing step, preferably selected from cleaning, coating with at least one sizing agent, drying and combinations of at least two of these treatment steps. In order to clean the fibers after electrochemical oxidation, they can be subjected to a washing process. Washing is used specifically to remove fiber fragments. Washing is usually followed by a drying step. To modify the surface properties, the fibers can be at least partially coated with at least one sizing agent. The sizing agent can be used, for example, in the form of a solution in a suitable solvent or in the form of a dispersion. For applying the coating, for example, the fibers can be passed through a sizing bath. The size can be at least partially removed from the fibers during hydroentanglement in step c). If the water used in step c) for bonding the fibrous web is at least partially recycled, it can be advantageous to subject the waste water from the hydroentanglement process to a treatment in which the size contained in the waste water is partially or completely removed.

After coating the fibers with at least one sizing agent, they are usually subjected to (further) drying. Drying can be carried out in each case, for example, by using hot air, hot plates, heated rollers or radiant heaters.

The precursors of carbon fibers thus obtained can be used and further processed as fiber composition in step a) of the process according to the present disclosure. Alternatively, a fiber composition containing PAN fibers or consisting of PAN fibers can be subjected to pyrolysis at a temperature of at least 1000° C., whereby the PAN precursors are converted to carbon fibers. With regard to the pyrolysis conditions, reference is made to the following embodiments in step e). The carbon fibers thus obtained can also be used and further processed as fiber composition in step a) of the process according to the present disclosure.

### Step B

In step b) of the method according to the present disclosure, the fiber composition provided in step a) is subjected to a process for manufacturing a fibrous web (carbon fiber nonwoven and/or carbon fiber precursor nonwoven). Suitable processes for the manufacture of nonwovens are known to the skilled person and are described, for example, in H. Fuchs, W. Albrecht, Vliesstoffe, 2nd ed. 2012, p. 121 ff., Wiley-VCH. These include, for example, dry processes, wet processes, extrusion processes and solvent processes. In a preferred embodiment, the fiber composition provided in step a) is subjected to a drylaying process to manufacture a fibrous web in step b). The production of drylaid nonwovens can in principle be carried out using a carding process or an aerodynamic process. In the carding process, a fibrous web is formed by a carding machine or a card, whereas in aerodynamic processes, nonwovens are formed from fibers with the aid of air. If desired, the fibrous webs can be stacked in several layers to form a nonwoven. The drylaying process in step b) can include a modification of the properties, e.g. by web drafting. Thereby, for example, a calibration of the nonwoven thickness and/or a pre-bonding of the fibrous web can take place.

### Step C

In step c) of the method according to the present disclosure, the fibrous web obtained in step b) is bonded to form a nonwoven by the action of aqueous fluid jets. Aqueous fluid jets also include fluid streams and steam jets.

In principle, suitable for hydroentanglement are the mechanical bonding processes known for this purpose, also known as spunlace processes. In principle, the so-called steam jet technology, in which superheated steam jets are used for nonwoven bonding, is also suitable. Such processes are known to those skilled in the art. In a method for the mechanical bonding of nonwovens, water is directed at an increased pressure of around 20 to 500 bar through a large number of nozzles onto the nonwoven to be bonded. Thereby the nozzles are arranged in one or more rows in so-called nozzle strips. These nozzle strips have a large number of nozzles in each row. The maximum number of nozzles can be up to 20,000 nozzles per strip, with typical nozzle diameters ranging from 0.05 to 0.5 mm. The hole diameters of the nozzles generally have very small tolerances of less than 2 mm, for example. In order to achieve defect-free nonwovens, it is necessary that the hole diameters of the nozzles do not change during operation and, in particular, that the nozzles do not become blocked.

It has been found that the pH value of the water used for bonding the fibrous web (nonwoven) is essential for the quality of the gas diffusion layers produced therefrom for use in fuel cells. Therefore, it is a critical feature of the method according to the present disclosure that the water used for bonding the nonwoven in step c) has a pH value (based on 25° C.) in the range from 5.5 to 8.0, preferably in the range from 5.5 to 7.0, preferably in the range from 6.0 to 6.9.

It has further been found that the conductivity of the water used for bonding the fibrous web (nonwoven) is essential for the quality of the gas diffusion layers produced therefrom for use in fuel cells. Therefore, the water used for bonding the nonwoven in step c) preferably has a conductivity of at most 250 microsiemens/cm (μS/cm) at 25° C. Preferably, the water used in step c) has a conductivity of at most 200 microsiemens/cm at 25° C., in particular of at most 150 microsiemens/cm at 25° C., especially of at most 100 microsiemens/cm at 25° C.

The electrical conductivity is a sum indicator for the ion concentration, i.e. the proportion of dissociated substances dissolved in a certain amount of water. The conductivity depends, among other things, on the concentration of the dissolved substances, their degree of dissociation and the valence and mobility of the cations and anions formed, as well as the temperature. The conductivity measurement is based on the determination of the ohmic resistance of the water sample to be analyzed and/or the reciprocal of the resistance, the electrical conductance (unit Siemens S=Ω⁻¹). Commercially available conductivity meters (conductometers) can be used to measure conductivity. The measured values are usually given in S/cm (Siemens per centimeter) or in microsiemens per centimeter for water samples with a low ionic load.

Process and service water for industrial processes usually comes from the public drinking water network or is pumped from wells, rivers and lakes. Drinking water and process water for processes that are critical in terms of water quality is usually checked for its ingredients and, if necessary, subjected to water treatment processes. Thereby the requirements for water purity are extremely diverse depending on the respective area of application. Drinking water is supplied as a clear, colorless liquid, free of odors and harmful microorganisms and substances, however enriched with essential minerals and salts. This water is of food-grade quality, but is not necessarily suitable for many technical application areas. According to the Drinking Water Ordinance (TrinkwV 2001, new version dated Mar. 10, 2016), drinking water in Germany must have a pH value of 6.5 to 9.0, usually it is in the range of 7.0 to 8.5. The threshold value for conductivity according to the Drinking Water Ordinance lies at 2790 microsiemens/cm at 25° C. The tap water supplied by German waterworks has a conductivity of 250 to 1000 microsiemens/cm at 25° C., depending on the hardness level. Na⁺, K⁺, Ca²⁺ and Mg²⁺ make up the majority of the inorganic cations.

Preferably, the water used in step c) has a content of Na⁺ ions of at most 200 ppm by weight, preferably of at most 25 ppm by weight.

Preferably, the water used in step c) has a content of K⁺ ions of at most 200 ppm by weight, preferably of at most 10 ppm by weight.

Preferably, the water used in step c) has a content of Mg²⁺ ions of at most 10 ppm by weight.

Preferably, the water used in step c) has a content of Ca²⁺ ions of at most 200 ppm by weight, preferably of at most 40 ppm by weight.

To provide the water used in step c) according to the present disclosure, an available drinking or process water can be subjected to treatment to adjust the pH value and/or to reduce the ion concentration. This includes ion exchange, electro deionization, membrane processes such as nanofiltration, reverse osmosis and electrodialysis, thermal processes such as distillation, flash evaporation, etc.

In an embodiment, nanofiltration, reverse osmosis or a combination of these processes is used to reduce the ion concentration. Both nanofiltration and reverse osmosis are based on the fact that the water to be treated is passed through a semipermeable membrane under a pressure that is higher than the osmotic pressure, whereby a permeate with a reduced ion concentration is obtained. Nanofiltration takes place at lower pressures than reverse osmosis and therefore has a lower purification performance than reverse osmosis, but is sufficient in many cases. A pre-cleaning is also provided using nanofiltration and a further reduction of the ion concentration using subsequent reverse osmosis.

In an embodiment, an ion exchange process is used for the reduction of the ion concentration. For this purpose, an available drinking or process water (raw water) is generally brought into contact with at least one cation exchange resin and with at least one anion exchange resin. In a suitable embodiment, the raw water is first treated with at least one strongly acidic cation exchanger, so that an exchange of the cations present in the water for hydrogen ions (H⁺) takes place. Subsequently the water thus obtained is treated with at least one strongly basic anion exchanger in order to exchange negatively charged ions for hydroxide ions (OH⁻). If necessary, the water obtained after being brought into contact with the cation exchanger can, in addition, be brought into contact with at least one weakly basic anion exchanger before the strongly basic exchanger. If necessary, the water can be subjected to carbon dioxide degasification after the cation exchanger or, if present, between the weakly basic and the strongly basic anion exchanger.

To adjust the properties of the water used in step c), two or more starting waters of different compositions can be mixed. These differ in at least one property, such as the pH value or the content of a certain type of ion. In an embodiment, a mixture of at least one water with a lower pH value and at least one water with a higher pH value than the target value is used to adjust the pH value of the water used in step c). In an embodiment, a mixture of at least one water with a lower pH obtained by nanofiltration or reverse osmosis and at least one water with a higher pH obtained by ion exchange is used to adjust the pH of the water used in step c).

Of importance for the pH value of the water used in step c) is the content of CO₂ and the dissociation of the carbonic acid formed therefrom. Particularly relevant for the process according to the present disclosure is the first dissociation stage from CO₂ and water to form hydrogen carbonate anions (HCO₃⁻) and oxonium ions (H O₃⁺), which takes place in the range between pH 4.3 and pH 8.2. In drinking or process water, the concentration of the dissolved carbon dioxide can range from a few milligrams per liter to over 20 mg/l, depending on the source. The concentration of hydrogen carbonate anions in drinking or process water can be several 100 g/l, depending on the source. Due to the absorption of carbon dioxide from the ambient air, pure water usually has a slightly acidic pH value and distilled water can reach acidic pH values of around 5.8. Only freshly produced distilled water has a pH value of around 7, but as soon as it comes into contact with carbon dioxide, a slightly acidic pH value results within a few hours.

The influence of dissolved carbon dioxide on the pH value depends on the process selected for the treatment of the raw water. Hydrogen carbonate anions, for example, can be effectively separated from the raw water using processes such as ion exchange, nanofiltration and reverse osmosis. This is not the case for dissolved CO₂, which is essentially not retained by the membranes used for nanofiltration and reverse osmosis, for example. As a result, the permeate from nanofiltration or reverse osmosis generally has an acidic pH value due to the dissociation of the dissolved carbon dioxide, which can be less than pH 6. In addition, hydrogen carbonate is thereby formed from the dissolved CO₂ and thus the conductivity is increased accordingly. In an embodiment, the raw water can therefore be subjected to carbon dioxide degasification before treatment in a nanofiltration or reverse osmosis.

A CO₂ trickler, for example, can be used for carbon dioxide degasification. In this process, the water is trickled in a column and strip air is fed in countercurrent, which leads to the removal of CO₂ from the water. Alternatively or additionally, a membrane degasification process can be used for carbon dioxide degassing.

In an embodiment of the method according to the present disclosure, the water used in step c) for bonding the fibrous web is partially or completely recycled. The method according to the present disclosure thus provides for reducing the amount of fresh water required and the amount of waste water to be disposed of for hydroentanglement. Thereby it is ensured that the water used for the treatment the fibrous web always has a conductivity within the range according to the present disclosure and that contamination of the fibrous web with components contained in the waste water from the hydroentanglement process is also avoided. For this purpose, the waste water from the hydroentanglement process can be partially or completely subjected to a treatment and/or exchanged.

The treatment and/or exchange of the waste water from the hydroentanglement system can be carried out continuously or at intervals.

A preferred method is one in which a fibrous web is bonded to form a nonwoven by the action of aqueous fluid jets, a waste water stream is discharged from the treatment of the fibrous web, a nominal value for the conductivity of the waste water stream is determined, the actual value of the conductivity of the waste water stream is determined, after a threshold value for the deviation of the actual value from the nominal value has been reached, the waste water stream is at least partially subjected to treatment and/or exchange with water of lower ionic concentration and the waste water stream is at least partially returned to the treatment of the fibrous web.

For treatment, the waste water stream can be subjected to a reduction in the ion concentration as described above. In addition, the waste water stream can be subjected to a further cleaning, e.g. to remove fibers and fiber fragments.

### Step D

If necessary, the nonwoven obtained in step c) can be subjected to a thermal and/or mechanical treatment for drying and/or further bonding. Suitable drying processes are convection drying, contact drying, radiation drying and combinations thereof.

Preferably, the nonwovens obtained in step c) are subjected to a calendering treatment. Calendering allows further thermal bonding of the nonwoven and simultaneously a thickness calibration. Thereby also several nonwoven layers can be bonded together. In an embodiment, the nonwoven obtained in step c) contains thermoplastic fibers that serve as binding fibers and are usually be carbonizable. In this case, thermal calendar bonding of the nonwoven can take place in step d), forming binding points at which fibers are plasticized and welded together (thermobonding).

### Step E

If the fiber composition used in step a) comprises precursors of carbon fibers, the nonwoven is subjected to pyrolysis at a temperature of at least 1000° C. in step e). Depending on the pyrolysis temperature, a distinction is made between carbonization and graphitization. Carbonization refers to a treatment at about 1000 to 1500° C. in an inert gas atmosphere, which leads to the separation of volatile products. Graphitization, i.e. heating to around 2000 to 3000° C. in an inert gas atmosphere, produces so-called high modulus or graphite fibers. During pyrolysis, for example, the carbon content increases from approx. 67% by weight when treated at temperatures below 1000° C. to approx. 99% by weight when treated at temperatures above 2000° C. In particular, the fibers obtained by graphitization have a high purity, are light, high-strength and very good conductors of electricity and heat.

### Step F

Optionally, the nonwoven can be finished with at least one additive following step c), d) or e). The additives are preferably selected from hydrophobizing agents f1), conductivity-improving additives f2), other additives f3) different from f1) and f2) and mixtures thereof.

Preferably, the nonwoven is coated and/or impregnated (finished) with a hydrophobizing agent f1) which contains at least one fluorine-containing polymer. Preferably, the fluorine-containing polymer is selected from polytetrafluoroethylenes (PTFE), tetrafluoroethylene-hexafluoropropylene copolymers (FEP), perfluoro alkoxy polymers (PFA) and mixtures thereof. Perfluoro alkoxy polymers are, for example, copolymers of tetrafluoroethylene (TFE) and perfluoro alkoxy vinyl ethers, such as perfluoro vinyl propyl ether. Preferably, a polytetrafluoroethylene is used as the fluorine-containing polymer.

Preferably, the percent by weight of the fluorine-containing polymer f1) is 0.5 to 40%, preferably 1 to 20%, in particular 1 to 10%, based on the weight of the nonwoven. In an embodiment, the fluorine-containing polymer is PTFE and percent by weight of the fluorine-containing polymer is 0.5 to 40%, preferably 1 to 20%, in particular 1 to 10%, based on the weight of the nonwoven.

In many cases, the nonwoven already has good electrical and thermal conductivity due to the carbon fibers used, even without conductivity-improving additives. However, for the improvement of the electrical and thermal conductivity, the nonwoven can be additionally finished with at least one conductivity-improving additive f2). Preferably the nonwoven is finished with a conductivity-improving additive f2), which is selected from metal particles, carbon black, graphite, graphene, carbon nanotubes (CNT), carbon nanofibers and mixtures thereof. Preferably, the conductivity-improving additive f2) comprises carbon black or consists of carbon black. The nonwoven can be finished with at least one conductivity-improving additive f2), for example together with the polymer f1) and/or other additives f3). Preferably, an aqueous dispersion is used for the finishing of the nonwoven.

Preferably, the percent by weight of the conductivity-improving additive f2) is 0.5 to 45%, preferably 1 to 25%, based on the weight of the nonwoven. In an embodiment, the conductivity-improving additive f2) comprises carbon black or consists of carbon black and the percent by weight is 0.5 to 45%, preferably 1 to 25%, based on the weight of the nonwoven.

The nonwovens can, in addition, be finished with at least one further additive f3). These include, for example, from the components f1) and f2) various polymeric binding agents, surface-active substances, etc. Suitable binding agents f3) are, for example, furanic resins, etc. In particular, the nonwovens can be additionally finished with at least one polymer different from f1), whereby the use of high-performance polymers is preferred. The other polymers f3) are preferably selected from polyaryletherketones, polyphenylene sulfides, polysulfones, polyether sulfones, partially aromatic (co) polyamides, polyimides, polyamideimides, polyetherimides and mixtures thereof. The nonwoven can be finished with at least one additive f3), for example together with the polymer f1) and/or conductivity-improving additives f2). The binding agents f3) can be subsequently hardened, if necessary. This can take place, for example, together with the drying and/or sintering following the finishing with the polymers f1) or also separately therefrom.

Preferably, the total percent by weight of further additives f3) is 0 to 80%, preferably 0 to 50%, based on the weight of the nonwoven. If the nonwovens additionally contain at least one further additive f3), the total percent by weight of further additives f3) is 0.1 to 80%, preferably 0.5 to 50%, based on the weight of the nonwoven.

The nonwoven preferably has a thickness in the range from 50 to 500 μm, preferably from 100 to 400 μm. This thickness refers to the unfinished, uncompressed state of the nonwoven, i.e. before the GDL is installed in a fuel cell.

The finishing of the nonwoven can be carried out with the components f1), f2) and/or f3) by application methods known to the skilled person, such as in particular coating and/or impregnation. Preferably, a method selected from padding, doctoring, spraying, slop-padding and combinations thereof is used for coating and/or impregnating the nonwovens.

In the padding process, the nonwoven is passed through a foulard (dip tank) with the additive-containing solution or dispersion and subsequently squeezed to the desired application quantity of additive using a pair of rollers that can be adjusted for pressure and/or gap.

In the doctor blading process a distinction is made between gravure printing and screen printing. In gravure printing, for example, a knife-like polished steel strip with or without a supporting doctor blade is used as a doctor blade. It is used to remove (doctoring off) the excess additive-containing solution or dispersion from the lands of the printing cylinder. In screen printing, on the other hand, the doctor blade is usually made of rubber or plastic with a sharp or rounded edge.

During spray application, the additive-containing solution or dispersion is applied to the nonwoven to be finished by means of at least one nozzle, in particular at least one slotted nozzle.

The slop-padding process (kiss-roll) is preferably used to coat the material underside of horizontally running webs. The coating medium can be applied to the web in the opposite direction or in the same direction. Indirect coating with small application quantities can be achieved using transfer rollers.

In an embodiment, the nonwoven finished with components f1), f2) and/or f3) in step f) of the method according to the present disclosure is subjected to drying and/or thermal treatment. Suitable processes for drying and/or thermal treatment of nonwovens coated and/or impregnated with additive-containing solutions or dispersions are known in principle. Preferably, the drying and/or thermal treatment is carried out at a temperature in the range from 20 to 250° C., preferably 40 to 200° C. In addition, drying can take place at a reduced pressure.

### Step G

In an embodiment, the gas diffusion layer according to the present disclosure comprises a two-layer composite based on a nonwoven and a microporous layer (MPL) on one of the surfaces of the nonwoven. For the production of the gas diffusion layer, the nonwoven obtained in step c), d), e) or f) can be coated with a microporous layer.

In contrast to the macroporous nonwoven, the MPL is microporous with pore diameters that are generally well below one micrometer, preferably of no more than 900 nm, preferably of no more than 500 nm, especially of no more than 300 nm. The average pore diameter of the MPL is preferably in the range from 5 to 200 nm, preferably from 10 to 100 nm. The average pore diameter can be determined by mercury porosimetry. The MPL contains conductive carbon particles, preferably carbon black or graphite, in a matrix of a polymeric binder. Preferred binders are the aforementioned fluorine-containing polymers, especially polytetrafluoroethylene (PTFE).

The microporous layer preferably has a thickness in the range from 10 to 100 μm (micrometers), preferably from 20 to 50 μm. This thickness refers to the uncompressed state of the microporous layer B), i.e. before the GDL is installed in a fuel cell.

The gas diffusion layer according to the present disclosure preferably has a thickness (total thickness of nonwoven and MPL) in the range from 80 to 1000 μm, preferably from 100 to 500 μm. This thickness refers to the uncompressed state of the GDL, i.e. before it is installed in a fuel cell.

In an embodiment, the present disclosure provides a fuel cell comprising at least one gas diffusion layer as defined above, or obtainable by a process as defined above. In principle, the gas diffusion layer according to the present disclosure is suitable for all conventional fuel cell types, in particular low-temperature proton exchange membrane fuel cells (PEMFC). Reference is made in full to the above-mentioned embodiments for the structure of fuel cells.

Embodiments of the invention are explained with reference to the following examples, which are not to be understood as limiting.

### Examples

The metal contents (Ca²⁺, Na⁺, Mg²⁺ and K⁺) of the base nonwovens made from oxidized polyacrylonitrile fibers, the thereof resulting carbonized nonwovens and GDL were determined using an ICP-AES method (Inductively Coupled Argon Plasma-Atomic Emission Spectrometry). The pretreatment of the samples (the digestion) can be carried out according to EPA Method 3050A for acid digestion of sediments, sludges and soils. This process includes the following steps:
1.) Nitric acid digestion at 95° C. for 15 minutes.
2.) Further addition of nitric acid while continuing the digestion for 1 h.
3.) Removing from the hotplate; adding deionized water and 20% hydrogen peroxide solution.
4.) Heating again on the hotplate for approx. 15 minutes and removing from the hotplate once the bubbles have completely stopped forming.
5.) Adding concentrated hydrochloric acid and digesting again for 1 hour.

For hydroentanglement, water with a conductivity according to the following Table 1 was used. The reference water 1 corresponds to a process water, as is usual for use in conventional methods for web bonding with water jets. The ion concentration of water batches 2 and 3 was reduced by nanofiltration.

TABLE 1

| Water batch | Conductivity [microsiemens/cm] | pH value^{#)} |
|---|---|---|
| V1 | 290 | — |
| (comparison) | | |
| 2 | 100 | 6.1 |
| 3 | 22 | 6.1 |

^{#)}determined according to DIN EN ISO 10523-C5: 2012-04

### Manufacture Example

For the manufacture of a basic nonwoven, a drylaid fibrous web of 100% oxidized polyacrylonitrile fibers was deposited on a carding machine. The fibrous web was fed to a bonding unit in which the fibers are entangled and intertwined on both sides by means of high-energy water jets at pressures of approx. 100 bar in the first stage and approx. 200 bar in the second stage. The water qualities listed in Table 1 were used. The nonwoven was dried and rolled up, wherein the basis weight was 150 g/m² after hydroentanglement and drying. The nonwoven was then subjected to a thickness calibration, whereby the thickness of the hydroentangled nonwoven was reduced to 0.25 mm. Subsequently the nonwoven was fed to a carbonization unit, in which carbonization took place under a nitrogen atmosphere at around 1000 to 1400° C.

For finishing the nonwoven, an impregnating composition containing 70% carbon black and 30% PTFE in relation to the solid material was used. Finishing was carried out by padding impregnation with an aqueous dispersion with a finishing weight of 15% based on weight of the GDL substrate (corresponding to 15 g/m²). This was followed by drying at 180° C. and sintering at 400° C. To the thus resulting substrate, an MPL paste containing 2.0 wt. % PTFE and 7.8 wt. % carbon in distilled water was then applied. The nonwoven was then dried at 160° C. and sintered at 400° C. The resulting MPL loading was 24 g/m².

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for manufacturing a gas diffusion layer for a fuel cell, comprising:
a) providing a fiber composition comprising carbon fibers and/or precursors of carbon fibers;
b) subjecting the fiber composition provided in step a) to a process for manufacturing a fibrous web;
c) bonding the fibrous web to form a nonwoven by action of aqueous fluid jets, wherein water used has a pH value in a range from 5.5 to 8.0,
d) subjecting the nonwoven obtained in step c) to a thermal and/or mechanical treatment for drying and/or further bonding,
e) subjecting the nonwoven to pyrolysis at a temperature of at least 1000° C. based on whether the fiber composition used in step a) comprises precursors of carbon fibers.

2. The method according to claim 1, wherein the water used in step c) for bonding the fibrous web has a pH value in a range from 5.5 to 7.0.

3. The method according to claim 1, wherein the water used in step c) for bonding the fibrous web has a conductivity of at most 250 microsiemens/cm at 25° C.

4. The method according to claim 1, wherein as a further step f), the nonwoven obtained in step c), d) or e) is additionally finished with at least one additive selected from hydrophobizing agents f1), conductivity-improving additives f2), further additives f3) and mixtures thereof.

5. The method according to claim 4, wherein the nonwoven obtained in step c), d), e) or f) is additionally coated with a microporous layer.

6. The method according to claim 1, wherein the fiber composition provided in step a) comprises precursors of carbon fibers selected from unoxidized polyacrylonitrile fibers, oxidized polyacrylonitrile fibers and mixtures thereof.

7. The method according to claim 1, wherein the fiber composition provided in step a) additionally comprises further fibers selected from fibers of phenolic resins, polyesters, polyolefins, cellulose, aramids, polyether ketones, polyether ester ketones, polyether sulfones, polyvinyl alcohol, lignin, pitch and mixtures thereof.

8. The method according to claim 1, wherein the fiber composition provided in step a) comprises polyacrylonitrile fibers.

9. The method according to claim 1, wherein the fiber composition provided in step a) is subjected in step b) to a drylaying process for manufacturing a fibrous web.

10. The method according to claim 1, wherein the water used in step c) for bonding the fibrous web is at least partially recycled.

11. The method according to claim 10, further comprising:
discharging a waste water stream from treatment of the fibrous web;
determining a nominal value for conductivity of the waste water stream;
determining an actual value of the conductivity of the waste water stream;
after reaching a threshold value for a deviation of the actual value from the nominal value, at least partially subjecting the waste water stream to treatment and/or exchange with water of lower ion concentration; and
at least partially returning the waste water stream into the treatment of the fibrous web.

12. The method according to claim 1, wherein the nonwoven obtained in step c) is subjected to further bonding by calendering in step d).

13. The method according to claim 4, wherein the hydrophobizing agent f1) comprises at least one fluorine-containing polymer.

14. The method according to claim 4, wherein the conductivity-improving additive f2) is selected from metal particles, carbon black, graphite, graphene, carbon nanotubes (CNT), carbon nanofibers and mixtures thereof.

15. The method according to claim 4, wherein the further additive f3) is selected from polymeric binders, surfactants and mixtures thereof different from components-hydrophobizing agents f1) and conductivity-improving additives f2).

16. The method according to claim 4, wherein the nonwoven is subjected to a thermal treatment during or after the coating and/or impregnation with the hydrophobizing agent f1) in step f).

17. (canceled)

18. (canceled)

19. The method according to claim 1, further comprising forming a gas diffusion layer.

20. The method according to claim 1, further comprising forming a fuel cell comprising the gas diffusion layer.
